(19) United States
(12) Patent Application Publication
(10) Pub. No.: US 2011/0153842 A1
(43) Pub. Date: Jun. 23, 2011

(54) CONTROL DEVICE, COMMUNICATION SYSTEM AND COMMUNICATION METHOD FOR MULTIMEDIA STREAMING OVER A WIRELESS BROADBAND NETWORK

(75) Inventors: Cheng-Yuan Chuang, Yangmei Township (TW); Yi-Ping Tsai, Bade City (TW)

(73) Assignee: GEMTEK TECHNOLOGY CO., LTD., Hukou (TW)

(21) Appl. No.: 12/882,650

(22) Filed: Sep. 15, 2010

(30) Foreign Application Priority Data
Dec. 21, 2009 (TW) 098143897

(51) Int. Cl. G06F 15/16

(52) U.S. Cl. 709/227; 709/231

(57) ABSTRACT

A control device, which is for use during multimedia streaming between a user terminal and a base station over a wireless broadband network, includes a parsing unit, a computing unit and a processing unit. The parsing unit parses a session signal for establishing a multimedia streaming session so as to acquire a call ID and a media descriptor of the multimedia streaming session. The computing unit receives the media descriptor thus acquired by the parsing unit, and computes a bandwidth needed for the multimedia streaming session based on the media descriptor. The processing unit receives the call ID and the bandwidth, and transmits a quality-of-service request signal to the base station according to the bandwidth and corresponding to the multimedia streaming session so as to request the base station to provide a quality of service corresponding to the bandwidth during the multimedia streaming session.

### CROSS-REFERENCE TO RELATED APPLICATION

This application claims priority of Taiwanese Application No. 098143897, filed on Dec. 21, 2009.

### BACKGROUND OF THE INVENTION

1. Field of the Invention

The present invention relates to a control device, a communication system and a communication method for multimedia streaming over a network, more particularly to a control device, a communication system and a communication method for multimedia streaming over a wireless broadband network.

2. Description of the Related Art

With reference to FIG. 1, current broadband communication network access technologies are categorized into wired connection and wireless connection. In the case of wired connection, a user terminal 711 (e.g., a personal computer) can be connected to a communication network 8 via a T1, a xDSL, or a cable modem 712.

In the case of wireless connection, a user terminal 81 can be connected to the communication network 8 via Worldwide Interoperability for Microwave Access (WiMAX). WiMAX was developed to provide high-speed, quality-of-service (QoS) enabled wireless broadband “last mile” connections between a base station (BS) 80 and user terminals 81.

The protocols and specifications of WiMAX are specified in the IEEE 802.16 standards, among which, the IEEE 802.16d standard is for fixed network access, and the IEEE 802.16e standard is an amendment to the IEEE 802.16d standard to add mobility. Accordingly, mobile user terminals 811 (e.g., mobile phones) are connected to the base station 80 using the IEEE 302.16e standard, and each of fixed user terminals 81 of different zones 9 is connected to the base station 80 via a subscriber station (SS) 82 using the IEEE 802.16d standard.

Nevertheless, conventional wireless broadband subscriber equipments are unable to achieve high-quality multimedia streaming under the IEEE 802.16d standards.

### SUMMARY OF THE INVENTION

Therefore, the object of the present invention is to provide a control device, a communication system and a communication method that can achieve quality-of-service (QoS) control during multimedia streaming over a wireless broadband network.

According to one aspect of the present invention, there is provided a control device for use during multimedia streaming between a user terminal and a base station over a wireless broadband network. The control device includes a parsing unit, a computing unit and a processing unit. The parsing unit parses a session signal generated by the user terminal for establishing a multimedia streaming session so as to acquire a call ID, multimedia streaming session information, and a media descriptor of the multimedia streaming session. The computing unit is coupled to the parsing unit for receiving the media descriptor thus acquired by the parsing unit therefrom, and computes a bandwidth needed for the multimedia streaming session based on the media descriptor. The processing unit is coupled to the parsing unit and the computing unit for respectively receiving the multimedia streaming session information (such as source IP, destination IP, source port and destination port) and the bandwidth therefrom, and transmits a quality-of-service request signal to the base station according to the bandwidth and corresponding to the multimedia streaming session so as to request the base station to provide a quality of service corresponding to the bandwidth during the multimedia streaming session.

According to another aspect of the present invention, there is provided a communication system adapted for use during multimedia streaming over a wireless broadband network. The communication system includes a base station and a control device capable of communicating with the base station. The control device includes a parsing unit, a computing unit and a processing unit. The parsing unit parses a session signal for establishing a multimedia streaming session so as to acquire a call ID and a media descriptor of the multimedia streaming session. The computing unit is coupled to the parsing unit for receiving the media descriptor thus acquired by the parsing unit therefrom, and computes a bandwidth needed for the multimedia streaming session based on the media descriptor. The processing unit is coupled to the parsing unit and the computing unit for respectively receiving the call ID and the bandwidth therefrom, and transmits a quality-of-service request signal to the base station according to the bandwidth and corresponding to the multimedia streaming session so as to request the base station to provide a quality of service corresponding to the bandwidth during the multimedia streaming session.

According to yet another aspect of the present invention, there is provided a communication method for multimedia streaming between a user terminal and a base station over a wireless broadband network. The communication method is adapted to be executed by a subscriber station connected between the user terminal and the base station, and includes the steps of: (a) upon receipt of a session signal for establishing a multimedia streaming session from the user terminal, parsing the session signal using the subscriber station to obtain a call ID and a media descriptor of the multimedia streaming session; (b) computing a bandwidth needed for the multimedia streaming session based on the media descriptor; and (c) transmitting a quality-of-service request signal to the base station according to the bandwidth thus obtained by the subscriber station and corresponding to the multimedia streaming so as to request the base station to provide a quality of service corresponding to the bandwidth during the multimedia streaming session.

The advantages of the present invention reside in that: by computing the bandwidth required by a multimedia streaming session during request for establishing a multimedia streaming session, and by requesting the base station to provide a quality of service according to the bandwidth, not only is quality-of-service (QoS) control provided, but effective utilization of the bandwidth is also ensured.

### BRIEF DESCRIPTION OF THE DRAWINGS

Other features and advantages of the present invention will become apparent in the following detailed description of the preferred embodiment with reference to the accompanying drawings, of which:

FIG. 1 is a schematic diagram for illustrating conventional broadband network communication technologies;

FIG. 2 is a block diagram for illustrating a communication system adapted for use during multimedia streaming over a wireless broadband network of the preferred embodiment according to the present invention, the communication system including a control device;

FIG. 3 is a block diagram for illustrating a management device of the control device according to the preferred embodiment;

FIG. 4 is a flowchart for illustrating first and second implementations of the communication method according to the preferred embodiment of the present invention;

FIG. 5 has two parts, FIG. 5A and FIG. 5B that cooperatively show a flowchart for illustrating a third implementation of the communication method according to the preferred embodiment of the present invention for an IP faxing application; and

FIG. 6 has two parts, FIG. 6A and FIG. 6B that cooperatively show a flowchart for illustrating control procedure performed by a subscriber station according to the preferred embodiment of the present invention.

### DETAILED DESCRIPTION OF THE PREFERRED EMBODIMENT

It should be noted herein that the term “multimedia streaming session” as used hereinafter generally means a real-time multimedia streaming session of at least one of sound, video, or image established by control signals based on the Session Initiation Protocol (SIP), the Media Gateway Control Protocol (MGCP), or the H.323 protocol, and may be a network television communication session, a video conferencing communication session, a network voice communication session, a network audio-video communication session, a network facsimile communication session, etc.

In the IEEE 802.16e standard, there are four quality-of-service (QoS) classes.

Unsolicited Grant Service (UGS) provides real-time, constant-bandwidth service. Data streams of UGS have constant packet length and periodic transmission intervals.

Real-time Polling Service (rtPS) provides real-time, variable-bandwidth service. Data streams of rtPS have variable packet length and periodic transmission intervals. Typical applications of rtPS are Voice over IP (VoIP) and MPEG streaming.

Non-Real-Time Polling Service (nrtPS) provides non-real-time, variable-bandwidth service. Data streams of nrtPS have variable packet length and non-periodic transmission intervals. Applications of nrtPS are usually delay-insensitive and do not require a constant bit rate. An example of nrtPS application is FTP file transfer.

Best Effort (BE) provides service for which no minimum service quality is required. Data streams of

BE are handled with the lowest priority in relation to the other classes. Typical applications of BE include E-mail and Short Messaging Service (SMS).

With reference to FIG. 2, a communication system 100 adapted for use during multimedia streaming over a wireless broadband network according to the preferred embodiment of the present invention includes a control device 1, a base station (BS) 2 and a user terminal 3. The control device 1 communicates with, and serves as a medium for one-way or two-way transmissions, between the base station 2 and the user terminal 3. In this embodiment, the control device 1 is a subscriber station (SS) 1, and the user terminal 3 is integrated with the subscriber station 1 for implementation as a network facsimile device. However, in other embodiments of the present invention, the subscriber station 1 and the user terminal 3 can be integrated for implementation as a network phone (e.g., a VoIP phone), a network video device (e.g., a network video conferencing device), a network facsimile device, or any other wireless multimedia streaming devices, or may be separate components. It should be noted herein that the subscriber station 1 and the control device 1 may be used interchangeably in this specification to refer to the component labeled with reference numeral “1”.

The subscriber station 1 includes a processor 10, a network transmission module 11, a radio frequency (RF) transmission module 12, a memory module 13 and an interface module 14 that communicate with each other via a bus.

The processor 10 is responsible for coordinating operations of the other modules of the subscriber station 1.

The network transmission module 11 is for establishing a wired connection between the subscriber station 1 and the user terminal 3. In an embodiment, the network transmission module 11 includes an Ethernet network physical interface (not shown) for communicating with the user terminal 3 via an RJ45 cable.

The RF transmission module 12 is for establishing a wireless connection between the subscriber station 1 and the base station 2, and includes a radio frequency (RF) transceiving component (not shown).

The memory module 13 is for storing data to be transacted, and includes a flash memory 131 and a synchronous dynamic random access memory (SDRAM) 132.

The interface module 14 is for testing or providing basic controls of the subscriber station 1, and includes interfaces such as SPI, serial, or JTAG.

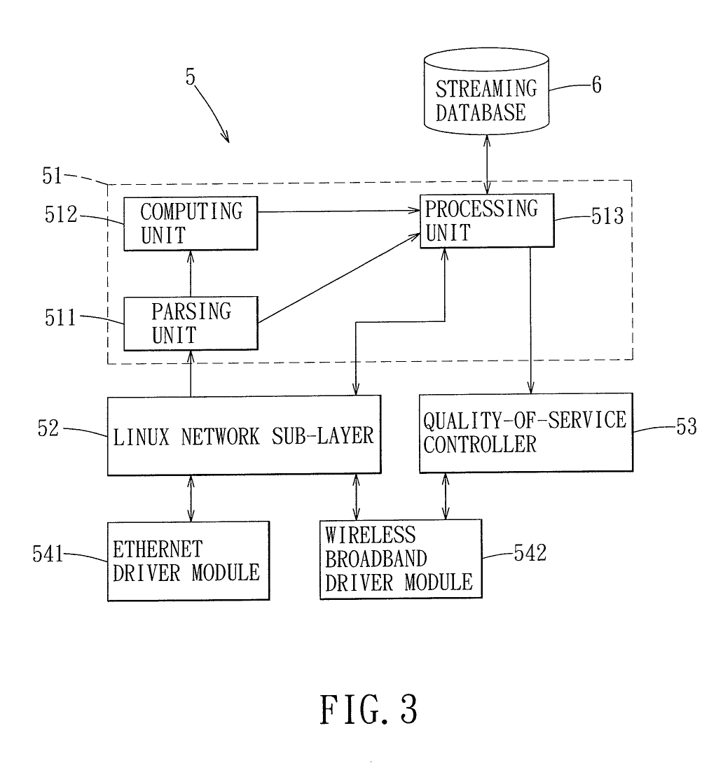

With reference to FIG. 3, the processor 10 of the subscriber station 1 is configured with a management device 5 by installing proprietary software. The management device 5 includes an application module 51, a Linux network sub-layer 52, a quality-of-service (QoS) controller 53, an Ethernet driver module 541, a wireless broadband driver module 542, and a streaming database 6.

With reference to FIG. 2 and FIG. 3, the application module 51, the Ethernet driver module 541 and the wireless broadband driver module 542 are located in the kernel space. The application module 51 communicates with the Ethernet driver module 541 via the Linux network sub-layer 52, and with the wireless broadband driver module 542 via the Linux network sub-layer 52 and the QoS controller 53. The Linux network sub-layer 52 communicates with the network transmission module 11 via the Ethernet driver module 541, and with the RF transmission module 12 via the wireless broadband driver module 542.

The application module 51 is configured with a parsing unit 511, a computing unit 512 and a processing unit 513. The parsing unit 511 is for parsing a session signal generated by the user terminal 3 for establishing a multimedia streaming session so as to acquire a call identification (call ID), multimedia streaming session information (such as source IP, destination IP, source port and destination port), and a media descriptor of the multimedia streaming session. An example of the call ID is 417c60fc_{—}12371c9323e@MTYTEST03. However, the call ID of a session signal is not limited to the aforementioned format as long as it qualifies as a unique identification code. Furthermore, for a session signal in compliance with Session Initiate Protocol (SIP) or Media Gateway Control Protocol (MGCP), the media descriptor is in the form of a Session Description Protocol (SDP) packet, and is used to exchange detailed required information between two terminals between which the multimedia streaming session is to be established. As such, for session signals incompliance with SIP or MGCP signal protocols, the SDP packet is parsed to acquire the media descriptor.

The computing unit 512 is coupled to the parsing unit 511 for receiving the media descriptor thus acquired by the pars ing unit 511 therefrom, and computes a bandwidth needed for the multimedia streaming session based on the media descriptor.

The processing unit 514 is coupled to the parsing unit 511 and the computing unit 512 for respectively receiving the multimedia streaming session information and the bandwidth therefrom, and transmits a quality-of-service request signal to the base station 2 according to the bandwidth and corresponding to the multimedia streaming so as to request the base station 2 to provide a quality of service corresponding to the bandwidth during the multimedia streaming session. An example of the quality-of-service request signal is for requesting the base station 2 to reserve 92 kbps of data flow for transmission of a specific multimedia stream according to Real-time Polling Service (rtPS) service priority. The quality-of-service request signal is transmitted to the base station 2 via the wireless broadband driver module 542 and the RF transmission module 12.

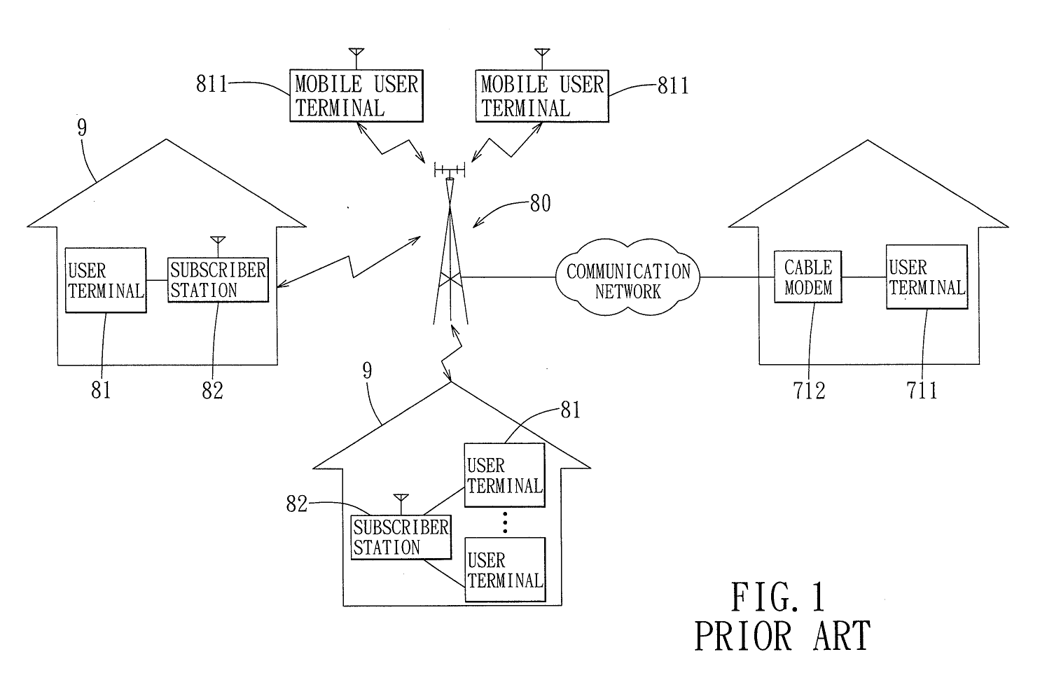

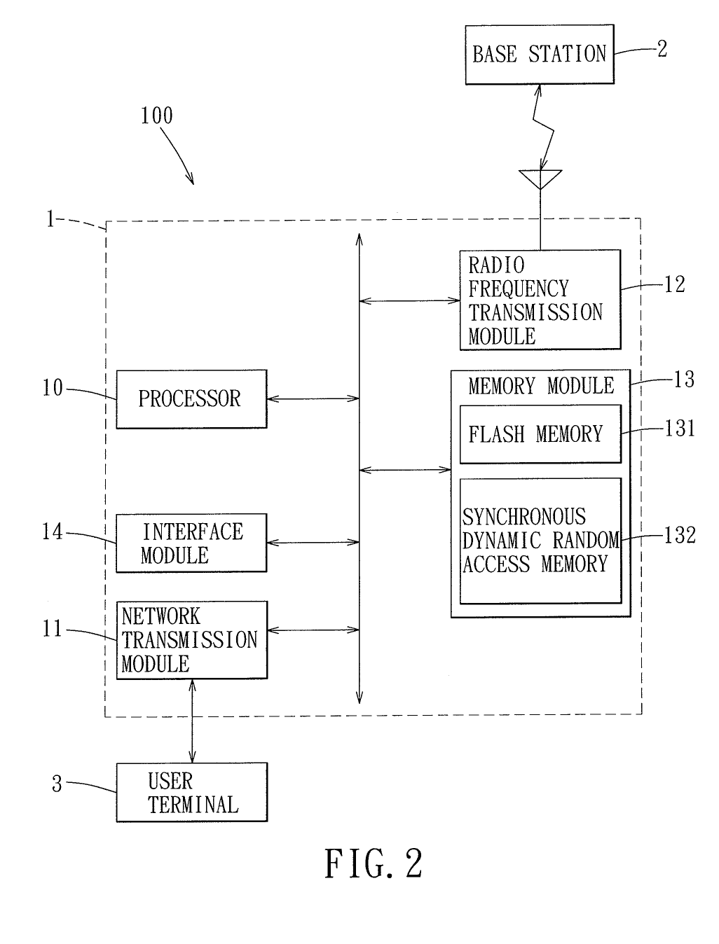

In this embodiment, the multimedia streaming session is established between the user terminal 3 and another user terminal in global Internet (such as component 711 or component 811 in FIG. 1) through the subscriber station 1 and the base station 2. The multimedia streaming session may be one of a network voice communication session, a network audio-video communication session and a facsimile communication session.

The communication method for multimedia streaming between the user terminal 3 and the base station 2 over a wireless broadband network according to the preferred embodiment of the present invention is adapted to be executed by the subscriber station 1 connected between the user terminal 3 and the base station 2, and includes the following steps.

Initially, upon receipt of a session signal for establishing a multimedia streaming session from the user terminal 3, the session signal is parsed using the parsing unit 511 of the subscriber station 1 to obtain a call identification (call ID) and a media descriptor of the multimedia streaming session. In particular, the parsing unit 511 parses the media descriptor in the session signal. The media descriptor will be apparent in the following description.

For example, if the user terminal 3 is implemented as a Fax over Internet Protocol (FoIP) device, i.e., a device that performs facsimile transactions via Voice over Internet Protocol (VoIP), then the session signal would be in compliance with the T.38 signal protocol. An example of the media descriptor in compliance with the T.38 signal protocol in the form of a Session Description Protocol (SDP) packet is provided below:

v=0 (SDP version)

o=−25678 753850 IN IP4 128.96.41.2 (owner: session ID=25678; session version=753850; network type=IN; address type=IP4; owner address=128.96.41.2)

s=−

c=IN IP4 128.96.41.2 (connection information)

t=0 0

m=image 1296 udptl t38 (media descriptor: media type=image; media port=1296; transport protocol=udptl; codec type=t38)

a=sqn: 0 (sequence number (capacity configuration code))

a=cdsc: 1 audio RTP/AVP 0 18 (cdsc(capacity description): capacity number=1; media type=voice; transmission protocol=RTP/AVP; load type=0, 18)

a=cdsc: 3 image udptl t38 (cdsc(capacity description): capacity number=3; media type=image; transmission protocol=udptl; load type=t38)

a=T38 maxBitRate:14400 (the maximum transmission speed for T.38)

Next, after the media descriptor parsed by the parsing unit 511 is transmitted to the computing unit 512, the computing unit 512 computes a bandwidth needed for the multimedia streaming session based on the media descriptor.

As apparent from the above SDP example, the media descriptor contains a codec type and a transport protocol. The bandwidth is computed according to the following formula:

(X+Y×Z×8)×(N)

where (X) represents a codec bit rate corresponding to the codec type contained in the media descriptor, (Y) represents a predetermined packet transmission rate, (Z) represents a total header length corresponding to the transport protocol contained in the media descriptor, and (N) represents a predetermined overhead percentage.

In the above SDP example, the codec type is t.38 (from the string “m=image 1296 udptl t38”), and the codec bit rate is 14400 (from the string “a=T38maxBitRate:14400”). The predetermined packet transmission rate can be obtained by dividing 1000 with a packet time, which is the time it takes for a packet to be sent, and which is normally 10 ms, 20 ms or 30 ms. In the above SDP example, no packet time is specified in the session signal, so a predefined packet time of 20 ms is used for the computation of the bandwidth. In the above SDP example, the image (i.e., the media) under the codec type of t.38 is encapsulated in UDP and IP layers, and thus the total header length is 20 (IP header length)+8 (UDP header length) =28 bytes. In the event that the media type is audio, the audio message would be encapsulated in RTP, UDP and IP layers, and the total header length would then be 12 (RTP header length)+8 (UDP header length)+20 (IP header length)=40bytes. The predetermined overhead percentage is 115% for WiMAX and RTCP (RTP (Real-time Transport Protocol) Control Protocol). Therefore, the total bandwidth for the above SDP example is computed as (14400+(1000/20) * (20+8)*8) * 115%=29440 bps.

An example of a media descriptor that is incompliance with Session Initiate Protocol (SIP) or Media Gateway Control Protocol (MGCP), the media descriptor being in the form of a Session Description Protocol (SDP) packet, is provided below:

v=0

o=alice 2890844526 2890844526 IN IP4 192.168.3.2

s=

c=IN IP4 192.168.3.2

t=0 0

m=audio 49170 RTP/AVP 0 8

a=rtpmap:0 PCMU/8000

a=rtpmap:0 PCMA/8000

a=ptime:20

By parsing the content of the SDP packet, it is known that the codec type is PCMU with a sampling rate of 8 bits at 8000 times per second, which means that the codec bit rate is 64 kbps (8000*8). The audio message is encapsulated in RTP, UDP and IP layers, and thus the total header length is 12 (RTP header length)+8 (UDP header length)+20 (IP header length)=40bytes. The packet time is 20 ms (from the string “a=ptime:20”), and thus the packet rate is 1000/20 bps. Therefore, the headers would occupy a bandwidth of ((1000/20) * (20+8+12) *8) bps. The total bandwidth is computed as (64000+(1000/20) * (20+8+12)*8) * 115%=92 kbps.

A multimedia streaming session may be a two-way streaming session (e.g., FoIP), or a one-way streaming session (e.g., call holding, voice mail services, etc.). The following is an example of a media descriptor for establishing a one-way multimedia streaming session in compliance with SIP or MGCP in the form of a SDP packet.

v=0

o=alice 2890844526 2890844526 IN 124 192.168.3.2

s=

c=IN 124 192.168.3.2

t=0 0

m=audio 49170 RTP/AVP 0 8

a=rtpmap:0 PCMU/8000

a=rtpmap:0 PCMA/8000

a=ptime:20

a=sendonly

By parsing the SDP content, it can be known from the string, “a=sendonly”, that the multimedia streaming session is one-way. The user terminal 3 that sends this session signal (or that initiates the invitation to establish the multimedia streaming session) will be transmitting, and not receiving, a multimedia stream. Under this circumstance, the subscriber station 1 only has to request for reservation of quality of service in one way (either downlink or uplink, and in this case, uplink). As described with reference to the previous example, a bandwidth of 92 kbps is required for the PCMU multimedia streaming session. Therefore, if the session signal is transmitted from the user terminal 3, the subscriber station 1 will only require 92 kbps of bandwidth to be reserved for an uplink session. On the other hand, if the session signal is transmitted from the base station 2, then the subscriber station 1 will only require 92 kbps of bandwidth to be reserved for a downlink session. Moreover, if the session signal contains the string, “a=recvonly”, and is generated by the user terminal 3, the subscriber station 1 will only. require 92 kbps of bandwidth to be reserved for a downlink session. Accordingly, if the session signal contains the string, “a=recvonly”, and is generated by the base station 2, the subscriber station 1 will only require 92 kbps of bandwidth to be reserved for an uplink session. As used herein, uplink refers to a flow of data from the user terminal 3 to the base station 2, and downlink refers to a flow of data from the base station 2 to the user terminal 3.

Below is an example of the media descriptor in compliance with the H.323 signal protocol.

AudioCapability: g711Alaw64k=160

The number “160” refers to the maximum number of audio frames per packet, and the bandwidth is computed as (64000+((64000/8)/160) * (20+8+12) * 8) * 115%=92 kbps.

It is noted herein that the session signal is passed on to the base station 2 from the subscriber station 1 while the bandwidth is being computed. When the processing unit 513 is informed by the computing unit 512 of the bandwidth, and receives an acknowledgement signal from the base station 2 acknowledging receipt of the session signal and informing acceptance of the invitation to establish the multimedia streaming session, the processing unit 513 transmits, via the QoS controller 53 and the wireless broadband driver module 542, a quality-of-service request signal to be transmitted to the base station 2 via the RE transmission module 12 according to the bandwidth thus obtained by the computing unit 512 and corresponding to the multimedia streaming session so as to request the base station 2 to provide a quality of service corresponding to the bandwidth during the multimedia streaming session. At this time, the processing unit 513 transmits the multimedia streaming session information (including streaming information (e.g., source address, destination address, source connecting port, destination connecting port, etc.), and quality of service information (e.g., quality-of-service type, reserved bandwidth, etc.)) in accordance with subsequent Real-time Transport Protocol (RTP) connection, and stores the multimedia streaming data in the streaming database 6.

Therefore, when the user terminal 3 wishes to establish a multimedia streaming session such as VoIP, video conferencing, or FoIP, etc., with the base station 2, the subscriber station 1 can request for a quality of service at the base station 2 based on the bandwidth required for the multimedia streaming session as computed according to the call ID and the media descriptor that are parsed from the session signal generated by the user terminal 3, such that the required quality of service is ensured during the multimedia streaming session.

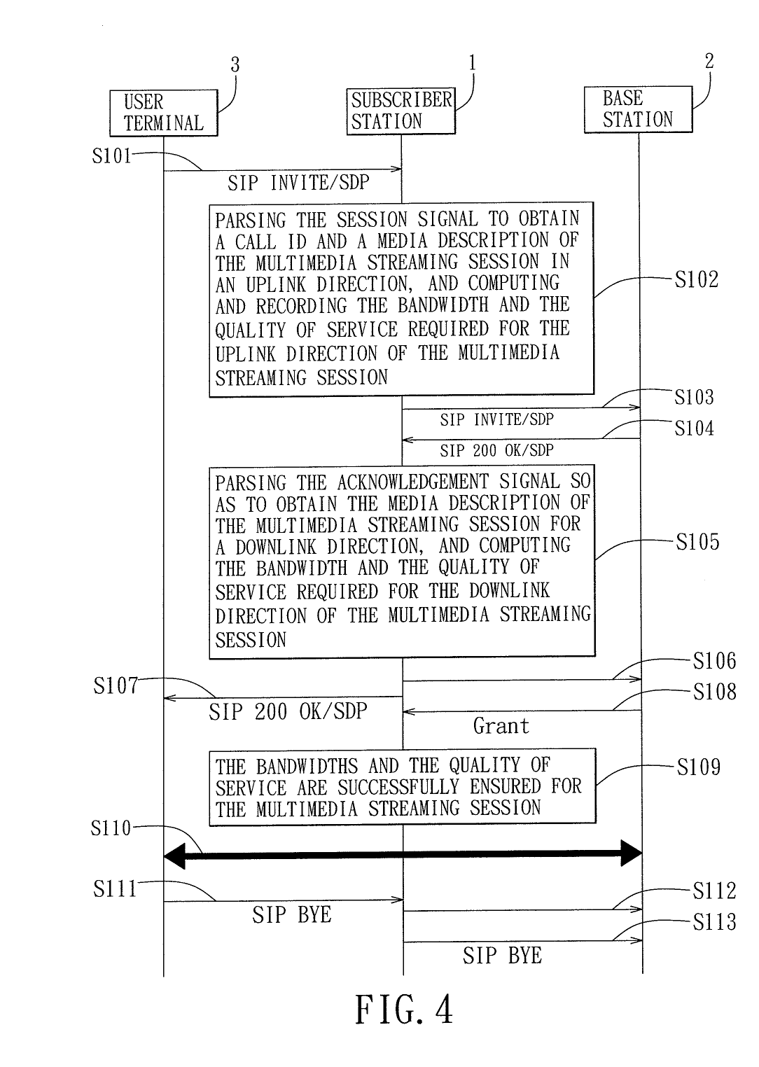

With reference to FIG. 4, a first implementation of the communication method according to the preferred embodiment of the present invention is shown to include the following steps for a two-way multimedia streaming application.

In step S101, the user terminal 3 transmits a session signal for establishing a multimedia streaming session to the subscriber station 1. In this example, the session signal is (SIP INVITE/SDP) according to Session Initiate Protocol (SIP). When the session signal reaches the subscriber station 1, the subscriber station 1 parses the session signal so as to obtain the call ID and the media descriptor of the multimedia streaming session for an uplink direction, and computes and records the bandwidth and the quality of service required for the uplink direction of the multimedia streaming session in step S102. Next, in step S103, the subscriber station 1 passes the session signal (SIP INVITE/SDP) to the base station 2. Subsequently, in step S104, the base station 2 acknowledges and accepts the invitation to establish the multimedia streaming session by generating and transmitting an acknowledgement signal (SIP 200 OK/SDP) back to the subscriber station 1. Then, in step S105, the subscriber station 1 parses the acknowledgement signal so as to obtain the media descriptor of the multimedia streaming session for a downlink direction, and computes the bandwidth and the quality of service required for the downlink direction of the multimedia streaming session. In the meantime, after the codec has been negotiated between the two peers (through steps S101 and S104), if necessary, the subscriber station 1 also updates the bandwidth for the uplink direction, which has been computed in step S102. As used herein, uplink refers to a flow of multimedia streaming data from the user terminal 3 to the base station 2, and downlink refers to a flow of multimedia streaming data from the base station 2 to the user terminal 3.

In step S106, after acquiring the bandwidths required for both the uplink and downlink directions of the multimedia streaming session, the subscriber station 1 transmits a quality-of-service request signal to the base station 2 according to the bandwidths thus obtained by the subscriber station 1 in steps S102 and S105 and corresponding to the multimedia streaming session so as to request the base station 2 to provide a quality of service corresponding to the bandwidths during the multimedia streaming session. For instance, the base station 2 may be requested to reserve a 92 kbps data flow in both the downlink and uplink directions during the multimedia streaming session according to Real-time Polling Service (rtPS) service priority. In step S107, the subscriber station 1 passes the acknowledgement signal (SIP 200 OK/SDP) to the user terminal 3. It should be noted herein that the sequence for performing steps S106 and S107 maybe interchanged. Subsequently, if the base station 2 has sufficient bandwidth, the quality-of-service request will be approved, where the base station 2 transmits an approval signal (Grant) to the subscriber station 1 and reserves the necessary bandwidths for the multimedia streaming session in step S108. At this point, the bandwidths and the quality of service are successfully ensured for the multimedia streaming session (step S109). Transmission of data for the multimedia streaming session takes place in step S110 under the required bandwidths and the required quality of service. To end the multimedia streaming session, the user terminal 3 transmits an end signal, such as (SIP BYE), to the subscriber station 1 in step S111. Then, the subscriber station 1 notifies the base station 2 of the same so as to inform the base station 2 that reservation of the bandwidths is no longer required, and that the bandwidths may be made available for other connections in step S112. Finally, in step S113, the base station 2 passes the end signal (SIP BYE) to the base station 2 for terminating the multimedia streaming session.

Still referring to FIG. 4, a second implementation of the communication method according to the preferred embodiment of the present invention is shown to include the following steps for a one-way multimedia streaming application.

In step S101, the user terminal 3 transmits a session signal (SIP INVITE/SDP) for establishing a multimedia streaming session to the subscriber station 1. The subscriber station 1 parses the session signal so as to obtain the call ID and the media descriptor of the multimedia streaming session for an uplink direction, and computes and records the bandwidth and the quality of service required for the uplink direction of the multimedia streaming session in step S102. The subscriber station 1 then passes the session signal (SIP INVITE/SDP) to the base station 2 in step S103. Next, the base station 2 acknowledges and accepts the invitation to establish the one-way multimedia streaming session by transmitting an acknowledgement signal (SIP 200 OK/SDP) back to the subscriber station in step S104. Subsequently, in step S105, the subscriber station 1 parses the acknowledgement signal so as to obtain the media descriptor of the multimedia streaming session for a downlink direction from which the subscriber station 1 knows that there is no need for reservation of bandwidth and quality of service for the downlink direction. After the codec has been negotiated between the two peers (through steps S101 and S104), if necessary, the subscriber station 1 also update uplink bandwidth which computes in step S102 in the meantime.

In step S106, the subscriber station 1 transmits a quality-of-service request signal to the base station 2 according to the bandwidth thus obtained by the subscriber station 1 in step S102 and corresponding to the multimedia streaming session so as to request the base station 2 to provide a quality of service corresponding to the bandwidth during the multimedia streaming session. In step S107, the subscriber station 1 passes the acknowledgement signal (SIP 200 OK/SDP) to the user terminal 3. Subsequently, if the base station 2 has sufficient bandwidth, the quality-of-service request will be approved, and the base station 2 transmits an approval signal (Grant) to the subscriber station 1 in step S108. At this point, the bandwidth and the quality of service are successfully ensured for the multimedia streaming session (step S109). Transmission of data for the multimedia streaming session takes place in step S110 under the required bandwidth and the required quality of service.

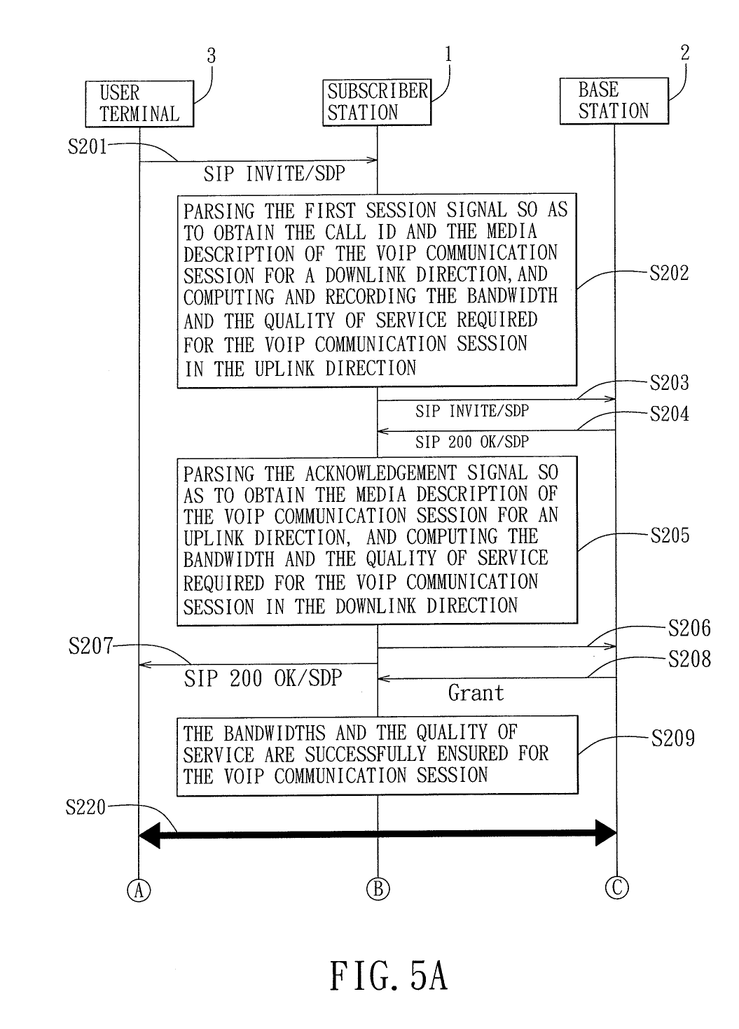

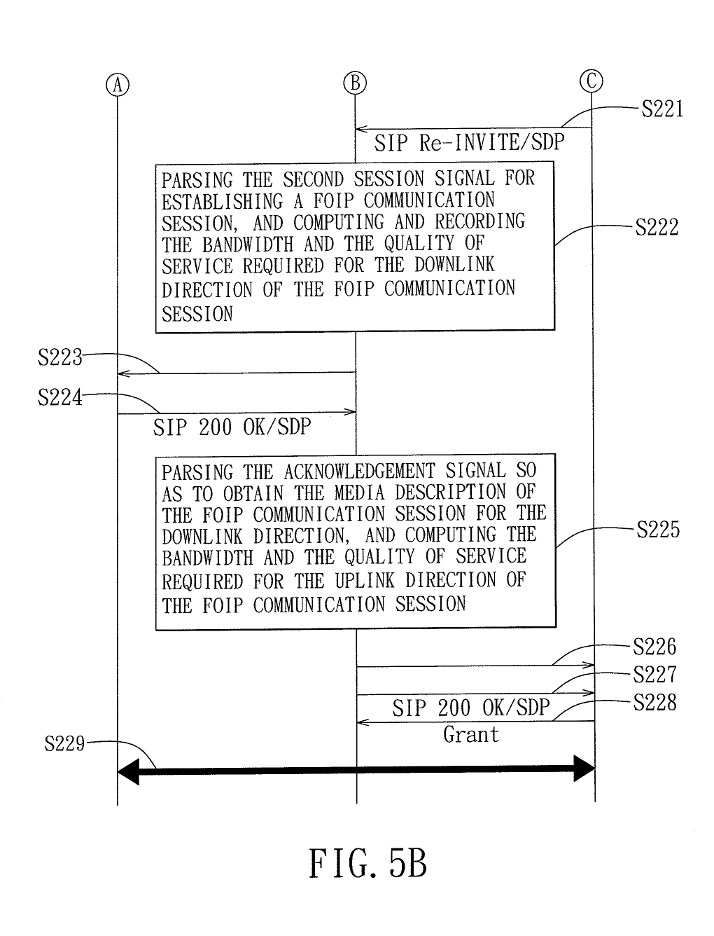

Referring to FIG. 5, a third implementation of the communication method according to the preferred embodiment of the present invention is shown to include the following steps for an IP faxing application, i.e., a Fax over Internet Protocol (FoIP) application. For FoIP applications, there needs to be two user terminals 3, one for transmitting (hereinafter referred to as a “transmitting user terminal”) and the other for receiving (hereinafter referred to as a “receiving user terminal”). Only the transmitting user terminal 3 will be discussed in the following description, and descriptions related to the communication between the receiving user terminal (not shown) and the base station 2 are omitted herein.

For a FoIP communication session, a Voice over Internet Protocol (VoIP) communication session is first established between the transmitting user terminal 3 and the receiving user terminal, and the transmitting user terminal 3 converts the packets to be transmitted into a codec that complies with a network facsimile protocol, e.g., T.38, for transmission of fax data. In this embodiment, the multimedia streaming session, whether it be a VoIP communication session, a video conference communication session, or a FoIP communication session, is provided with the desired quality of service through the following steps.

First, in step S201, the transmitting user terminal 3 sends a first session signal (SIP INVITE/SDP) for establishing a VoIP communication session to the subscriber station 1. Then, in step S202, the subscriber station 1 parses the first session signal (SIP INVITE/SDP) so as to obtain the call ID and the media descriptor of the VoIP communication session for an uplink direction, and computes and records the bandwidth and the quality of service required for the VoIP communication session in the uplink direction. It should be noted herein that the uplink direction as used in this particular example refers to the direction from the transmitting user terminal 3 to the receiving user terminal. Next, in step S203, the subscriber station 1 passes the first session signal (SIP INVITE/SDP) to the base station 2. Subsequently, in step S204, the receiving user terminal (not shown) acknowledges and accepts the invitation to establish the VoIP communication session by transmitting an acknowledgement signal (SIP 200 OK/SDP) via the base station 2 back to the subscriber station 1. Then, in step S205, the subscriber station 1 parses the acknowledgement signal so as to obtain the media descriptor of the VoIP communication session for a downlink direction, and computes the bandwidth and the quality of service required for the VoIP communication session in the downlink direction, and subscriber station 1 also update uplink bandwidth which computed instep S202 in the meantime. It should be noted herein that the downlink direction as used in this particular example refers to the direction from the transmitting user terminal to the receiving user terminal 3.

In step S206, after acquiring the bandwidths required for both the downlink and uplink directions of the VoIP communication session, the subscriber station 1 transmits a quality-of-service request signal to the base station 2 according to the bandwidths thus obtained by the subscriber station 1 in steps S202 and S205 and corresponding to the multimedia streaming session so as to request the base station 2 to provide a quality of service corresponding to the bandwidths during the VoIP communication session. In step S207, the subscriber station 1 passes the acknowledgement signal (SIP 200 OK/SDP) to the transmitting user terminal 3. It should be noted herein that the sequence for performing steps S206 and S207 may be interchanged. If the base station 2 has sufficient bandwidth, the quality-of-service request will be approved, and the base station 2 transmits an approval signal (Grant) to the subscriber station 1 and reserves the necessary bandwidths and quality of service for the VoIP communication session in step S208. At this point, the bandwidths and the quality of service are successfully ensured for the VoIP communication session (step S209). Transmission of data for the VoIP communication session takes place in step S220 under the required bandwidths and with the required quality of service.

Once the VoIP communication session is successfully established, the receiving user terminal transmits a second session signal (SIP Re-INVITE/SDP) to the subscriber station 1 via the base station 2 in step S221. The subscriber station 1 parses the second session signal (SIP Re-INVITE/SDP) for establishing a FoIP communication session, realizes from the media descriptor thereof that the codec is now in compliance with the T.38 communication protocol, and computes and records the bandwidth and the quality of service required for the downlink direction of the FoIP communication session in step S222.

Next, instep S223, the subscriber station 1 passes the second session signal (SIP Re-INVITE/SDP) to the transmitting user terminal 3. Subsequently, in step S224, the transmitting user terminal 3 acknowledges and accepts the invitation to establish the FoIP communication session by transmitting an acknowledgement signal (SIP 200 OK/SDP) back to the subscriber station 1. Then, in step S225, the subscriber station 1 parses the acknowledgement signal (SIP 200 OK/SDP) so as to obtain the media descriptor of the FoIP communication session for the uplink direction, and computes the bandwidth and the quality of service required for the uplink direction of the FoIP communication session. In the meantime, after the codec has been negotiated between the two peers (through steps S221 and S224), if necessary, the subscriber station 1 also updates the bandwidth for the downlink direction, which is computed in step S222. Then, in step S226, after acquiring the bandwidths required for both the downlink and uplink directions of the FoIP communication session, the subscriber station 1 transmits a quality-of-service request signal to the base station 2 according to the bandwidths thus obtained by the subscriber station 1 in steps S222 and S225 so as to request the base station 2 to provide a quality of service corresponding to the bandwidths during the FoIP communication session. In step S227, the subscriber station 1 passes the acknowledgement signal (SIP 200 OK/SDP) to the base station 2 to be further passed to the receiving user terminal. It should be noted herein that the sequence for performing steps S226 and S227 maybe interchanged. Since communication has been established between the transmitting user terminal 3 and the receiving user terminal with the VoIP communication session, the quality-of-service request signal transmitted in step S226 essentially provides the base station 2 with updated information regarding the required bandwidths and the required quality of service for communication between the transmitting user terminal 3 and the receiving terminal for an FoIP communication session. For instance, a flow rate of 88 kbps with nrtPS priority may be required of the base station 2 in the quality-of-service request signal for the FoIP communication session.

If the base station 2 has sufficient bandwidth, the quality of service request will be approved, and the base station 2 transmits an approval signal (Grant) to the subscriber station land reserves the necessary bandwidths for the FoIP communication session in step S228. At this point, the required bandwidths and the required quality of service are successfully ensured for the FoIP communication session (step S229), such that transmission of data for the FoIP communication session can take place under the required bandwidths and the required quality of service.

In such a manner, the subscriber station 1 is capable of updating the bandwidth reservation and quality of service request for a communication established between the user terminal 3 and the base station 2 so that the base station 2 is able to optimize the utilization of the bandwidths according to a new media descriptor when the nature of the communication changes (i.e., from one multimedia streaming session with a call ID and a media descriptor to another multimedia streaming session with another call ID and another media descriptor). Therefore, the problems, that occur after the nature of the communication changes, of either wasting unnecessary bandwidth or degradation in the quality of service due to insufficient bandwidth are avoided.

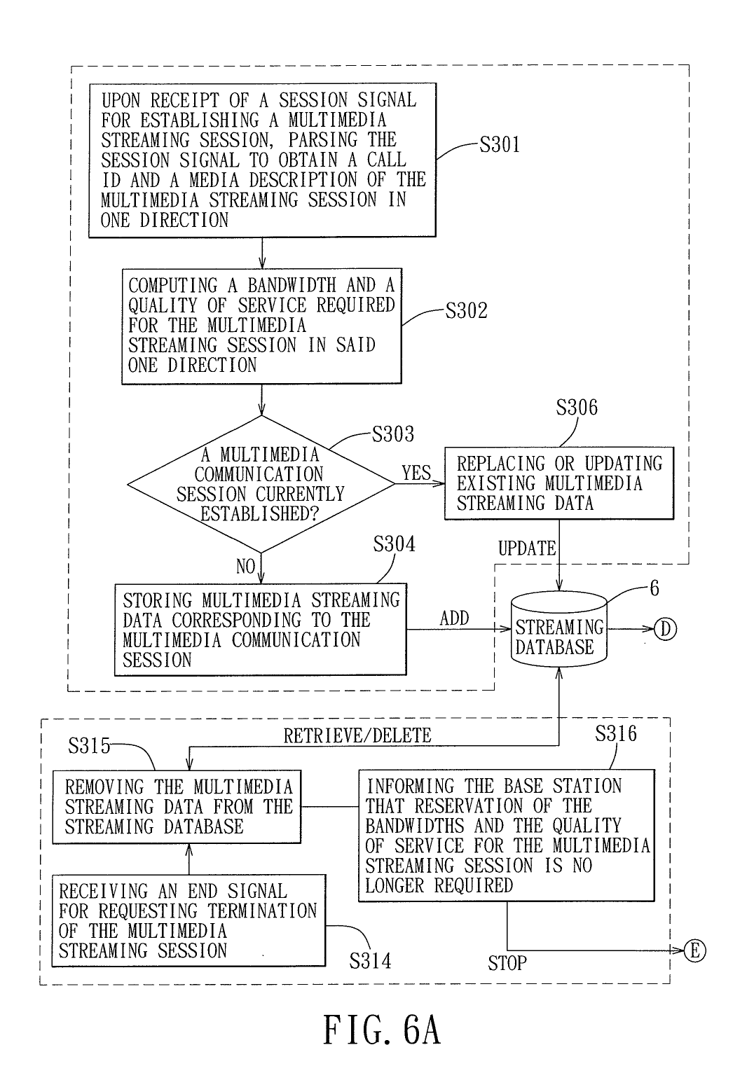

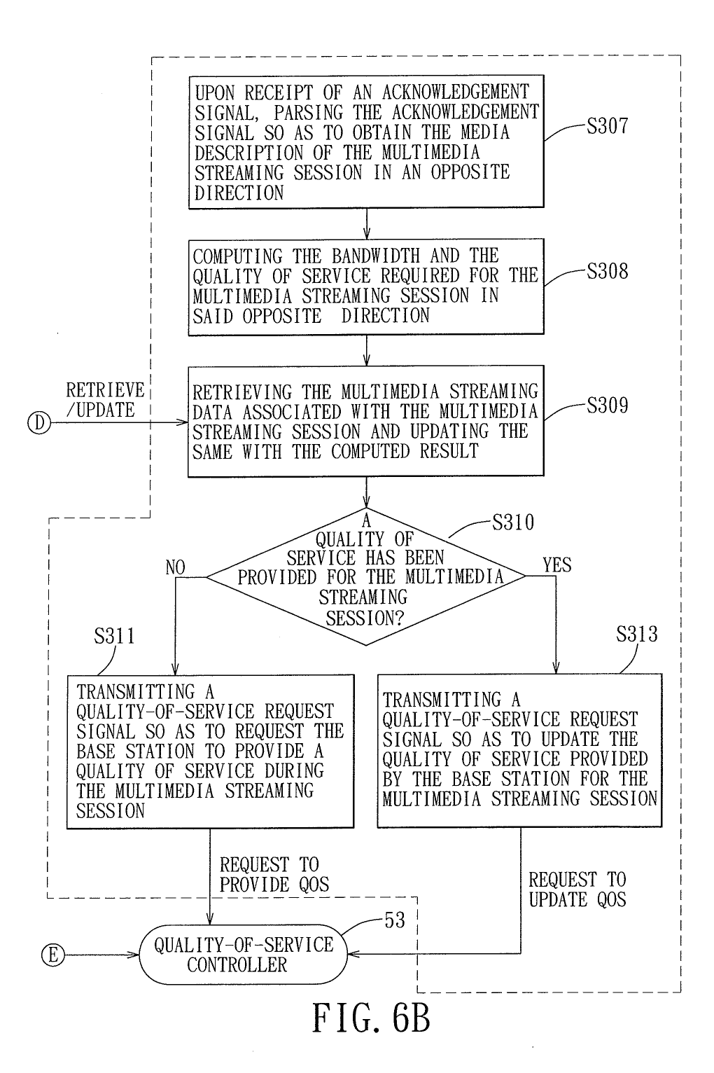

Shown in FIG. 6 is a detailed control procedure performed by the subscriber station 1 according to the preferred embodiment of the present invention. Reference is also made to FIG. 2 and FIG. 3.

In step S301, upon receipt of a session signal for establishing a multimedia streaming session from one of the user terminal 3 and the base station 2 (i.e., a transmitting party), the subscriber station 1 parses the session signal to obtain a call identification (call ID) and a media descriptor of the multimedia streaming session in a direction from the transmitting party to the other one of the user terminal 3 and the base station 2 (i.e., a receiving party). In step S302, the subscriber station 1 computes a bandwidth, as well as a quality of service, needed for the multimedia streaming session based on the media descriptor. Next, in step S303, it is determined whether a multimedia communication session is currently established between the user terminal 3 and another user terminal (not shown) in global internet (not shown). If it is determined in step S303 that no multimedia communication session is currently established, the process goes to S304, where multimedia streaming data corresponding to the multimedia communication session (including call ID, streaming information (e.g., source address, destination address, source connecting port, destination connecting port, etc.), and quality of service information (e.g., QoS type, reserved bandwidth, etc.)) is stored in the streaming database 6. If it is determined in step S303 that a multimedia communication session is currently established, the process goes to S306, where the existing multimedia streaming data in the streaming database 6 corresponding to the multimedia communication session established is replaced or updated with new multimedia streaming data corresponding to the currently-requested multimedia communication session.

On the other hand, upon receipt of an acknowledgement signal from the receiving party, the subscriber station 1 parses the acknowledgement signal so as to obtain the media descriptor of the multimedia streaming session in an opposite direction in step S307. Next, in step S308, the subscriber station 1 computes the bandwidth and the quality of service required for the multimedia streaming session in the opposite direction. Subsequently, the multimedia streaming data parsed and computed in steps S301 and S303 and associated with the multimedia streaming session is retrieved from the streaming database 6, and is updated with the computed result in step S309. In step S310, it is determined whether a quality of service has been provided for the multimedia streaming session. If not, the process goes to step S311, where the QoS controller 53 of the subscriber station 1 is notified that a quality-of-service request is needed for the multimedia streaming session, and a quality-of-service request signal is transmitted to the base station 2 according to the bandwidths thus obtained by the subscriber station 1 in steps S302, S308 and S309 and corresponding to the multimedia streaming session so as to request the base station 2 to provide a quality of service corresponding to the bandwidths during the multimedia streaming session. Otherwise, the process goes to step S313, where a quality-of-service request signal is transmitted to the base station 2 according to the bandwidths thus obtained by the subscriber station 1 in steps S302, S308 and S309 and corresponding to the multimedia streaming session so as to update the quality of service provided by the base station 2 for the multimedia streaming session.

As for termination of the multimedia streaming session, upon receipt of an end signal for requesting termination of the multimedia streaming session in step S314, the multimedia streaming data is removed from the streaming database 6 in step S315, and the QoS control module 53 is notified of the termination request and informs the base station 2 that reservation of the bandwidths and the quality of service for the multimedia streaming session is no longer required in step S316.

In summary, by using the subscriber station 1 to compute the bandwidth(s) required by a multimedia streaming session during request for establishing a multimedia streaming session, and to request the base station 2 to provide a quality of service according to the bandwidth, not only is quality-of-service (QoS) control provided, but effective utilization of the bandwidth of the base station 2 is also ensured. In addition, when the codec type is changed for the multimedia streaming session, the bandwidth reservation and the QoS type is promptly adjusted so as to ensure optimal utilization of the resources at the base station 2.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is :

1. A control device for use during multimedia streaming between a user terminal and a base station over a wireless broadband network, said control device comprising:
a parsing unit for parsing a session signal for establishing a multimedia streaming session so as to acquire a call ID and a media descriptor of the multimedia streaming session;
a computing unit coupled to said parsing unit for receiving the media descriptor thus acquired by said parsing unit therefrom, and computing a bandwidth needed for the multimedia streaming session based on the media descriptor; and
a processing unit coupled to said parsing unit and said computing unit for respectively receiving the call ID and the bandwidth therefrom, and transmitting a quality-of-service request signal to the base station according to the bandwidth and corresponding to the multimedia streaming session so as to request the base station to provide a quality of service corresponding to the bandwidth during the multimedia streaming session.

2. The control device as claimed in claim 1, wherein the media descriptor contains a codec type and a transport protocol, and said computing unit computes the bandwidth according to the following formula:
(X+Y×Z×8)×N
where (X) represents a codec bit rate corresponding to the codec type contained in the media descriptor, (Y) represents a predetermined packet transmission rate, (Z) represents a total header length corresponding to the transport protocol contained in the media descriptor, and (N) represents a predetermined overhead percentage.

3. The control device as claimed in claim 1, wherein said parsing unit parses the session signal with reference to signal format of one of session initiate protocol (SIP), media gateway control protocol (MGCP) and H.323 signaling protocols.

4. A communication system adapted for use during multimedia streaming over a wireless broadband network, comprising:
a base station; and
a control device capable of communicating with said base station, and including
a parsing unit for parsing a session signal for establishing a multimedia streaming session so as to acquire a call ID and a media descriptor of the multimedia streaming session,
a computing unit coupled to said parsing unit for receiving the media descriptor thus acquired by said parsing unit therefrom, and computing a bandwidth needed for the multimedia streaming session based on the media descriptor, and
a processing unit coupled to said parsing unit and said computing unit for respectively receiving the call ID and the bandwidth therefrom, and transmitting a quality-of-service request signal to said base station according to the bandwidth and corresponding to the multimedia streaming session so as to request said base station to provide a quality of service corresponding to the bandwidth during the multimedia streaming session.

5. The communication system as claimed in claim 4, further comprising a user terminal, the multimedia streaming session being established between said user terminal and another user terminal through said control device and said base station, and being one of a network voice communication session, a network audio-video communication session and a network facsimile communication session.

6. The communication system as claimed in claim 5, wherein said user terminal is integrated with said control device, and said control device is one of a network phone, a network video device and a network facsimile device.

7. The communication system as claimed in claim 5, wherein the media descriptor contains a codec type and a transport protocol, and said computing unit of said control device computes the bandwidth according to the following formula:
(X+Y×Z×8)×N
where (X) represents a codec bit rate corresponding to the codec type contained in the media descriptor, (Y) represents a predetermined packet transmission rate, (Z) represents a total header length corresponding to the transport protocol contained in the media descriptor, and (N) represents a predetermined overhead percentage.

8. The communication system as claimed in claim 5, wherein said parsing unit parses the session signal with reference to signal format of one of session initiate protocol (SIP), media gateway control protocol (MGCP) and H.323 signaling protocols.

9. A communication method for multimedia streaming between a user terminal and a base station over a wireless broadband network, the communication method being adapted to be executed by a subscriber station connected between the user terminal and the base station, the communication method comprising the steps of:
(a) upon receipt of a session signal for establishing a multimedia streaming session, parsing the session signal using the subscriber station to obtain a call ID and a media descriptor of the multimedia streaming session;
(b) computing a bandwidth needed for the multimedia streaming session based on the media descriptor; and
(c) transmitting a quality-of-service request signal to the base station according to the bandwidth thus obtained by the subscriber station and corresponding to the multimedia streaming session so as to request the base station to provide a quality of service corresponding to the bandwidth during the multimedia streaming session.

10. The communication method as claimed in claim 9, wherein the multimedia streaming session is a network voice communication session established between two user terminals through the subscriber station and the base station.

11. The communication method as claimed in claim 9, wherein the multimedia streaming session is a network audio-video communication session established between two user terminals through the subscriber station and the base station.

12. The communication method as claimed in claim 9, wherein the media descriptor contains a codec type and a transport protocol, the bandwidth being computed according to the following formula:
(X+Y×Z×8)×N
where (X) represents a codec bit rate corresponding to the codec type contained in the media descriptor, (Y) represents a predetermined packet transmission rate, (Z) represents a total header length corresponding to the transport protocol contained in the media descriptor, and (N) represents a predetermined overhead percentage.

13. The communication system as claimed in claim 9, wherein the session signal is parsed with reference to signal format of one of session initiate protocol (SIP), media gateway control protocol (MGCP) and H.323 signaling protocols.
